(19) United States
(12) Patent Application Publication
(10) Pub. No.: US 2026/0244219 A1
(43) Pub. Date: Aug. 20, 2026

(54) A METHOD FOR INTRODUCING AN AUTONOMOUS OR PARTIALLY AUTONOMOUS ROBOT UNDER A PARKED VEHICLE

(71) Applicant: CHARGING ROBOTICS LTD., Tel Aviv (IL)

(72) Inventors: Hovav GILAN, Kadima (IL); Michael LEVI, Tel-Aviv (IL); Itai SIMAN TOV, Jerusalem (IL); Orya MANDELBAUM, Jerusalem (IL); Doron SHABANOV, Tzur Yigal (IL)

(73) Assignee: CHARGING ROBOTICS LTD., Tel Aviv (IL)

(21) Appl. No.: 19/471,926

(22) PCT Filed: Mar. 28, 2024
(86) PCT No.: PCT/IL2024/050323

§ 371 Date: Oct. 2, 2025

Related U.S. Application Data
(60) Provisional application No. 63/457,145, filed on Apr. 5, 2023.

(51) Int. Cl. G05D 1/656; G05D 101/00; G05D 107/00; G05D 111/10

(52) U.S. Cl. CPC G05D 1/656; G05D 2101/22; G05D 2107/95; G05D 2111/17

(57) ABSTRACT

Disclosed herein is a method for determining the distance and orientation of an autonomous or partially autonomous mobile robot relative to a parked target vehicle from a base center located adjacent to the parked target vehicle. The distance and orientation are used by the robot to navigate from the base center to a target location under the ground clearance of the target vehicle.

### CROSS REFERENCE TO RELATED APPLICATIONS

This application is a U.S. National Stage of International Patent Application No. PCT/IL2024/050323, filed on Mar. 28, 2024, which is related to and claims the priority benefit of U.S. Provisional Application No. 63/457,145, filed on Apr. 5, 2023, each of which is incorporated herein in its entirety as if fully set forth below.

### FIELD OF THE INVENTION

The invention relates to the field of autonomous robotic vehicles. Specifically the invention relates to the navigational function of autonomous robotic vehicles. More specifically the invention relates to robotic vehicles configured to approach and move underneath a vehicle in order to carry out a specific task.

### BACKGROUND OF THE INVENTION

Publications and other reference materials referred to herein are numerically referenced in the following text and respectively grouped in the appended Bibliography which immediately precedes the claims.

Autonomous mobile robots are known that are capable of navigating underneath parked vehicles for various purposes including: safety and security inspections, charging electric vehicles, and lifting the vehicle to change tires or for other maintenance procedures.

One difficulty that is often encountered is choosing an appropriate entry place under the vehicle and aligning the robot with that entry place to allow fast and simple travel to the desired location under the vehicle.

It is a purpose of the present invention to provide a system and method that will allow autonomous mobile robots to propel itself under a parked vehicle in order to navigate along a predetermined route or to a predetermined location under the vehicle.

Further purposes and advantages of this invention will appear as the description proceeds.

### SUMMARY OF THE INVENTION

Disclosed herein is a method for determining the distance and orientation of an autonomous or partially autonomous mobile robot relative to a parked target vehicle from a base center located adjacent to the parked target vehicle. The distance and orientation are used by the robot to navigate from the base center to a target location under the ground clearance of the target vehicle. The method comprises:
a) activating a lidar sensor mounted on the robot;
b) receiving data from the lidar sensor at an onboard or remote processor;
c) executing software in the processor configured to carry out a method for locating a pair of wheels on the front, back, or a side from which the robot will enter under the target vehicle;
d) executing software in the processor to locate an entry point between the pair of wheels located on the previous step from which the robot will enter underneath the target vehicle; and
e) executing software in the processor that is configured to carry out a navigation process that directs the robot from the base center to the entry point and from there underneath the vehicle.

Embodiments of the method include a first step of navigating the robot to the base center, which faces a front, back, or a side surface of the target vehicle.

Embodiments of the method include a last step of executing software in the processor that is configured to carry out a navigation process that directs the robot from the entry point to the target location.

Embodiments of the method include both the first and the last steps.

In the method locating a pair of wheels comprises the steps of:
a) receiving raw data from a lidar sensor mounted on the robot;
b) applying the BIRCH algorithm on the raw data to find clusters of data points;
c) calculating the distance between all pairs of clusters;
d) determining if the distance between the two clusters in each of the pairs of clusters equals a predefined parameter plus or minus a predefined error, wherein; if the distance between clusters equals the parameter, then the pair is suspected to be a wheel pair and if the distance between clusters does not equal the parameter, then this pair is rejected;
e) applying a RANSAC algorithm to obtain a straight regression line on each of the two clusters from the pairs of clusters that are suspected to represent a pair of wheels;
f) calculate the angle between the two regression lines for each suspected pair; wherein, if the two regression lines are parallel, plus or minus a predefined error or if the two regression lines are perpendicular plus or minus a predefined error then it is certain that the pair of clusters represents a pair of wheels.

To carry out the method the maximum height of the robot and any sensors or equipment mounted on it must be lower than the ground clearance of the vehicle.

All the above and other characteristics and advantages of the invention will be further understood through the following illustrative and non-limitative description of embodiments thereof, with reference to the appended drawings.

### BRIEF DESCRIPTION OF THE DRAWINGS

FIGS. 1A to 1D schematically illustrates the method of locating wheels from the front of a target vehicle;

FIGS. 2A to 2C are enlarged views of the lidar points of group 2 in FIGS. 1A and 1B;

FIGS. 3A-3F schematically illustrates the method of locating wheels from the middle of one side of a target vehicle; and

FIGS. 4A and 4B schematically illustrate the navigational problem addressed by the present invention after a pair of wheels has been located.

### DETAILED DESCRIPTION OF EMBODIMENTS OF THE INVENTION

Presented herein is a method that allows a route to be determined by which an autonomous or partially autonomous mobile robot (herein “robot”) can navigate from a location adjacent to a parked vehicle (herein a “target vehicle”) to a location or along a route (herein a (“target location/route”) under the target vehicle. The initial proximity of the robot to the target vehicle is a function of the line of sight for the purpose of a sensor or sensors that is used to guide the robot. The target location as well as the target route can be predetermined or determined as the robot travels.

A detailed description of specific embodiments of mobile autonomous robots is not a part of the present invention. What is required is that the robot comprises: a drive train comprising four wheels, e.g. omnidirectional wheels, and a power source (typically one electric motor for each wheel); an energy source (typically a rechargeable battery or batteries to power the motors); a navigation system and control system comprising various types of onboard sensors and a computer system (comprising a processor, software, and memory); wireless communication components (to allow two way communication with a base station since some of the components of the navigation and control system can be either onboard or at a remote location); and the necessary components to carry out its mission (e.g. cameras for security inspections and a transmitting coil and power supply for inductive charging of an electric vehicle).

Methods by which the robot can propel itself and navigate from a charging station to a parked target vehicle, including avoiding obstacles in its path, are described in many places (for example in WO2022/144901 [1] to the applicant of the present invention). These methods and the devices necessary for these tasks are not relevant to the present invention. The assumption is that the robot “knows” how to find the target vehicle and also may have some knowledge about the model of target vehicle and its orientation in the coordinate system of the robot's navigational system or in its designated parking space so that the robot will know or be instructed how to approach the target vehicle, i.e. from front, rear, or one of the sides and also the target location or route under the target vehicle to which it is required to travel in order to execute its assigned task (e.g. the location of a receiving coil on the underside of an electric vehicle and a complete security scan of the underside of the target vehicle).

Once the robot arrives in the vicinity of the target vehicle a lidar sensor mounted on the robot is activated to obtain data used to identify pairs of wheels of the target vehicle, which in turn are used to identify an entry location, and to direct the robot to the entry point underneath the target vehicle from which it can continue under the vehicle to carry out its mission.

Since the robot must be able to propel itself under a vehicle, it has been determined that, in general, for passenger vehicles the maximum height of the robot and any sensors or equipment mounted on it including the lidar sensor will be, for example, 20 centimeters above the surface on which the vehicle is parked. However, robots can be provided for use with special cases such as sports models of passenger vehicles for which the ground clearance can be much lower and for other types of vehicles, e.g. semi-trailers for which the maximum height can be greater.

Since the robot is lower than the ground clearance of the vehicle, the only identified parts of the target vehicle are the wheels; therefore the robot, or a base station with which the robot communicates, comprises software comprising algorithms that can identify pairs of wheels from the raw lidar data and, using the location of the wheels relative to the robot, instruct the robot how to align itself with the center line of the target vehicle and to travel between the wheels and under the target vehicle along the target route or to the target location. In some situations, for example the presence of obstacles, the robot's travel route doesn't have to be a straight line. The robot's navigational software and sensors enable it to change direction during movement, for example to avoid an obstacle or to align itself with a receiving coil on an electric vehicle.

The method of locating pairs of wheels between which the robot can enter below the undercarriage of the target vehicle using data from the lidar scans is summarized by the following steps:
1. receive raw data from a lidar sensor mounted on the robot;
2. on the raw data use the BIRCH algorithm [2] to find clusters of data points, wherein each cluster is composed of the lidar pulses that impact on an individual object during a scan;
3. calculate distance between pairs of clusters;
4. if the distance between clusters equals a predefined parameter (which is the known distance between the wheels) plus or minus a predefined error, then these two clusters are suspected to be a wheel pair; if the distance between clusters does not equal the parameter, then this pair is rejected;
5. on each of the two clusters from the pairs of clusters that are suspected to represent a pair of wheels, calculate a straight regression line using a RANSAC algorithm [3] (note that RANSAC was chosen over other regression algorithms because of its better ability to omit outlier points);
6. calculate the angle between the two regression lines for each suspected pair;
7. if the two regression lines are parallel, plus or minus a predefined error, then it is certain that the pair of clusters represents a pair of wheels, this follows from the fact that for rear wheels the wheels are parallel as are the front wheels, even if the steering wheel is turned;
8. if the two regression lines are perpendicular plus or minus a predefined error (85-95 degrees for example), then it is certain that the pair of clusters represents a pair of wheels; and
9. if the two regression lines are at any other angle, then the pair of clusters are rejected as representing wheels.

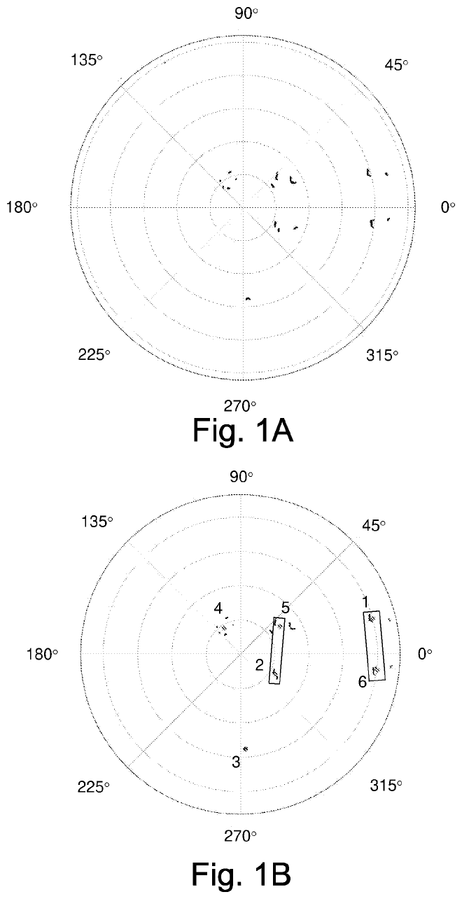

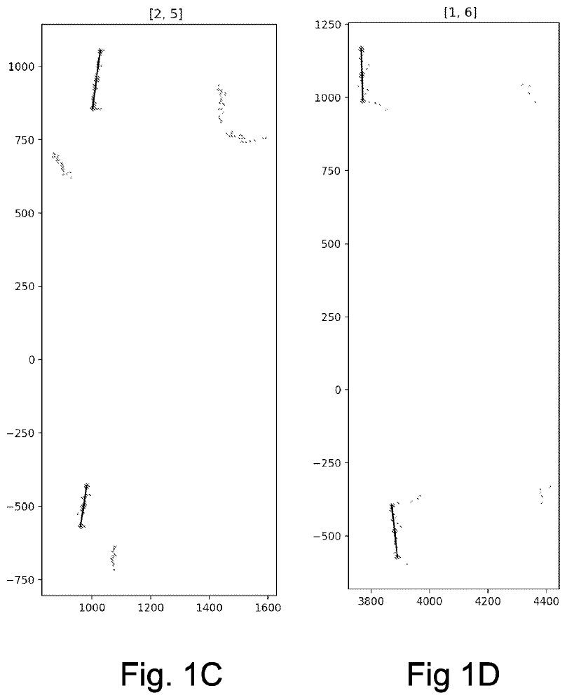

FIGS. 1A to 1D schematically illustrate the steps of the method described above for locating wheels from the front of a target vehicle. FIG. 1A represents the raw lidar data in polar coordinates (step 1). FIG. 1B represents the raw data after applying the BIRCH algorithm to find six clusters of data points, calculating the distance between pairs of clusters, and determining which distances equal the predefined parameter for the specific target vehicle (in this case there are two pairs of clusters, which are enclosed in rectangles, that satisfy the criterion to represent suspected pairs of wheels (steps 2-4). FIG. 1C and FIG. 1D each show the coordinates (converted to a Cartesian coordinate system) for one of the two pairs of clusters that form a suspected pair of wheels. In FIGS. 1C and 1D the RANSAC algorithm has been applied resulting in a straight regression line drawn on each cluster of the pair (step 5). In both FIGS. 1C and 1D the angles between the regression lines on the two clusters that make up the pair are calculated (step 6). In both FIG. 1C and FIG. 1D in this example the regression lines for the two clusters in each pair are parallel and therefore, because of the distance of the pair of clusters from the robot that is facing the front of the target vehicle, the pair of cluster in FIG. 1D identifies the rear wheels and the pair in FIG. 1C identifies the front wheels (step 7).

It is noted that, although all the examples herein relate to passenger cars, the method can also be applied to vehicles that have more than two sets of wheels such as semitrailers.

In FIGS. 1A and 1B the lidar sensor mounted on the robot is located at the center of the polar coordinate system and 0° direction points towards the front of the target vehicle. Each cluster of raw data points is identified by use of the BIRCH algorithm and assigned a three element identity label having the following structure: serial number of the cluster, angle in the polar coordinate system, and distance from the origin along a radius of the polar coordinate system. For example, the identity label of cluster 2 is [2, −29.0, 1158.7]. The identity labels for the clusters are not shown on the figures in this application to avoid cluttering them up with too many details that are not relevant to understanding the invention. Using the information in the identity labels, the distance between each two clusters is calculated to identify possible pairs of wheels.

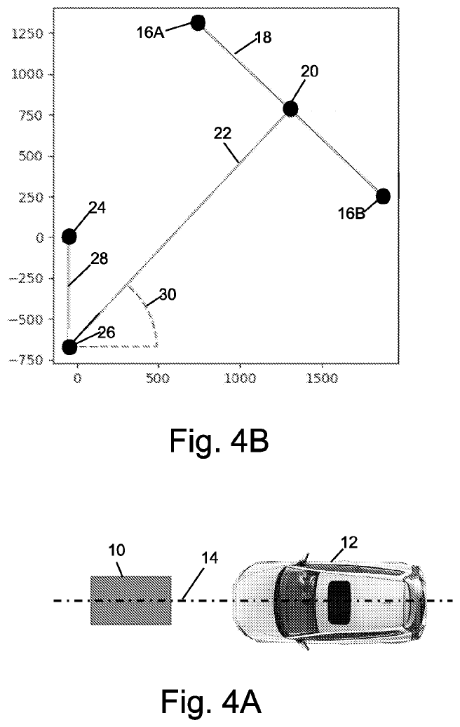

Once the possible pairs of clusters are determined, for example the pairs enclosed in rectangles in FIG. 1B, their coordinates are converted to a Cartesian coordinate system, such as shown in FIG. 1C for the pair of clusters 2 and 5 and FIG. 1D for the pair of clusters 1 and 6. In FIGS. 1C and 1D, the horizontal axis is the distance of the center of the clusters from the front of the robot and the vertical axis is the perpendicular distance in mm above and below (i.e. to the left and right when facing the target vehicle) of a straight line from the front of the robot to the center of the side of the target vehicle facing the robot during the lidar scan. In these figures, each cluster is represented by 3 dots, which lie on the regression line determined by applying the RANSAC algorithm to the points in the cluster. The central dot represents the center of the wheel and the other two dots are the edges of the regression line and physically correspond to the edges of the wheel as detected by the lidar sensor. The apparent width of a cluster in the lidar scan is another criterion that can be used to determine if that cluster actually represents a wheel. Each pair of groups shown in FIGS. 1C and 1D has a three element identity label having the following structure: {[x, x], [y, y], [z, z, z]} The first element [x, x] contains the serial numbers of the two clusters from FIG. 1B that represent each of the groups that form the pair suspected of representing a pair of wheels of the target vehicle. The element [y, y] [contains the widths of each of the tires. The first number in the third element [z, z, z] is the angle between the two lines generated by the RANSAC algorithm and the next two numbers represent the angles between each of the RANSAC lines and a line connecting the centers of the two RANSAC lines (line 18 in FIG. 4B). As an example, the identity label for the group shown in FIG. 1D is {[1,6], [175,176], [−5,2,2]. The complete identity labels for the other clusters are not shown on the figures in this application to avoid cramming the figures with too many details that are not relevant to understanding the invention.

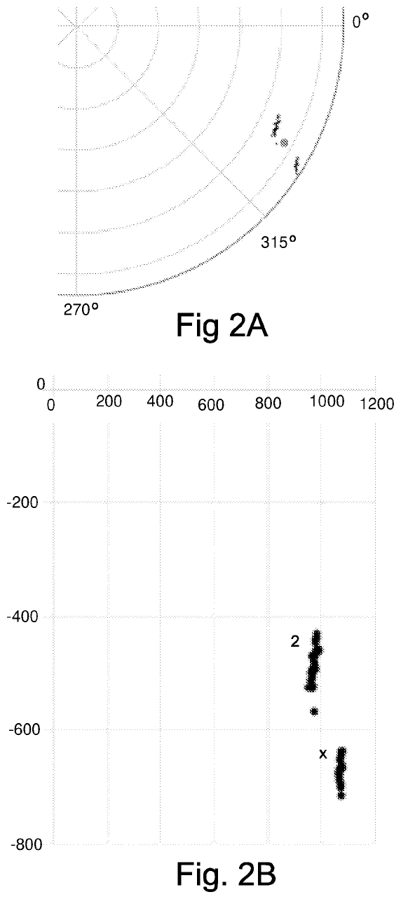

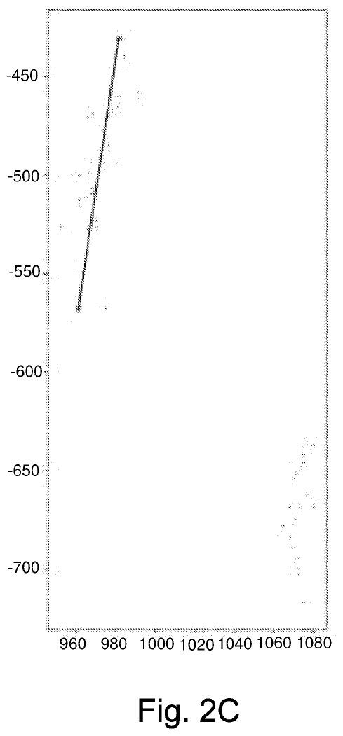

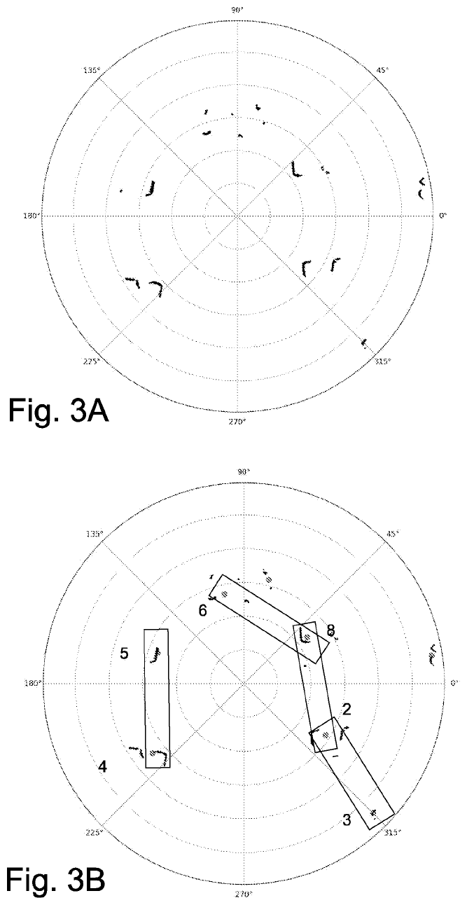

FIGS. 2A to 2C are enlarged views of the lidar points of group 2 in FIGS. 1A and 1B. These figures schematically illustrate the mathematical steps carried out to identify pairs of wheels according to the method described herein. FIG. 2A shows a portion of the raw lidar data concerning group 2. FIG. 2B shows the raw data converted to Cartesian coordinates after the Birch algorithm was applied to identify the lidar points associated with group 2 and another nearby group of points (labelled x in FIG. 2B) that later was determined to be an outlier that was not related to a wheel. FIG. 2C is an enlargement of a portion of FIG. 2B showing the regression line determined using the RANSAC algorithm on the lidar data for group 2.

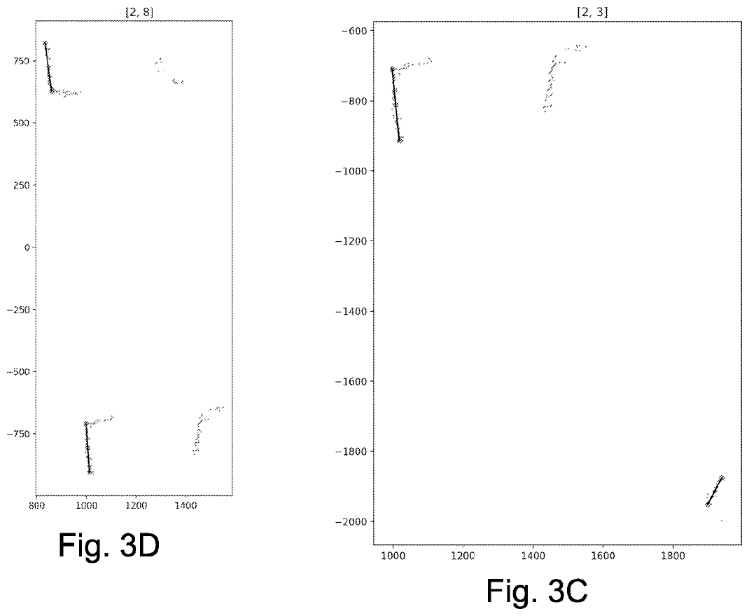

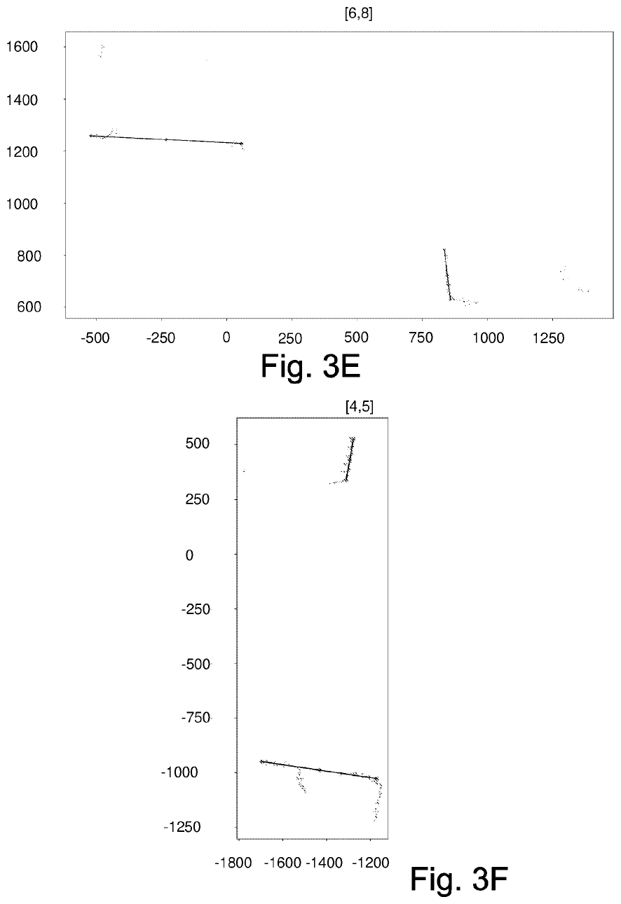

FIGS. 3A-3F schematically illustrates the method of locating wheels with the robot facing the middle of one side of a target vehicle. In these figures, as in similar FIGS. 1A-1D, circular FIG. 3A shows the raw lidar data, circular FIG. 3B represents the raw data after applying the BIRCH algorithm to find six clusters of data points, calculating the distance between pairs of clusters, and determining which distances equal the predefined parameter for the specific target vehicle, and the rectangles contain representations of the pairs of clusters determined to represent possible pairs of wheels of the target vehicle with regression lines calculated using the BIRCH algorithm for each cluster.

In FIG. 3B, four pairs of clusters that represent possible pairs of wheels have been identified based on the distance between the two groups that form the pair. Pair [2, 3] shown in FIG. 3C and pair [6, 8] shown in FIG. 3E are determined not to represent wheels because the angles between the regression lines of each member of the pair are neither parallel or perpendicular to each other (step 9 of the method). Pair [2, 8] shown in FIG. 3D is determined to represent a pair of wheels on the side of target vehicle facing the robot because the regression lines of the two groups are parallel (step 7). Pair [4, 5] shown in FIG. 3F is determined to represent a pair of wheels because the regression lines of the two groups are perpendicular to each other (step 8). In the case of F, the regression lines are perpendicular due to the location of the lidar scanner relative to the target vehicle. In this case the robot is facing the side of the target vehicle and the lidar scanner sees one wheel in the front (or rear) of the vehicle and one wheel on the side of the vehicle and it appears as if the wheels are perpendicular.

FIGS. 4A and 4B schematically illustrate one solution to the navigational problem addressed by the present invention. The solution shown in the example of these figures is a form of open loop navigation which takes place after robot 10 has reached at a position facing the front of a target vehicle 12 in order to enter the underside of the vehicle to carry out a certain task (e.g. a security scan, a wireless charging operation or others). In this example the robot 10 aligns itself with the central longitudinal symmetry axis 14 of the underside of the target vehicle 12 as shown in FIG. 4A, which, for example, is an example of a path that it would normally take to carry out a security scan from the front to the rear of the target vehicle 12 while cameras mounted on robot 10 scan in upward and sideward directions looking for suspicious objects. In other examples the robot can choose any route not only along the longitude axis by an algorithm. The onboard processor and software calculates such possible route alternatives from a current position to the target location under the target car, for example in order to avoid obstacles. In a different embodiment a processor and software at a base station for the robot can set constraints, for example for avoiding obstacles or can propose a route for the robot to follow.

FIG. 4B shows the situation after the robot 10 has travelled from its initial location, e.g. a charging station, and arrived in front of target vehicle 12 with the lidar sensor that is mounted on robot 10 positioned at a location named the base center 24. FIG. 1B is a plan view of the vicinity of the parked target vehicle 14. Distances in millimeters in the X (horizontal) and Y (vertical) directions in a Cartesian coordinate system having its origin at base center 24 are marked around edges of the figure. For the purpose of obtaining the scan data and making the calculation the robot may in one example stop for a short period of time at the base station 24 either for the scan to take place or for the calculation to be completed. In another example the robot obtains the data at the base station 24 and an algorithm calculates the required route taking into consideration the (short) distance 28 made from that base station 24; such short distance 28 is likely to be towards a location 26 on the orthogonal line 22 from the center 20 of a line 18 connecting the centers of the two wheels 16A and 16B. Alternatively the algorithm may calculate a route directly from base station 24 in the general direction of the target vehicle.

There may be several conditions that should be satisfied for allowing the method to successfully identify pairs of wheels on the target vehicle. These may include, for example the angle of the front wheels relative to the axis of the target vehicle should be relatively small and the base center should be a distance from the target vehicle that allows for a lidar scan to cover the entire side of the target vehicle without being so large that irrelevant data, such as from other nearby vehicles or objects appear in the scan. If the method fails to identify a set of wheels from the lidar data or if it is suspected that a false positive has been obtained, e.g. a set of wheels on a vehicle parked alongside the target vehicle, then the robot moves to a new base center 24, a new coordinate system is defined, new lidar data is obtained, and the algorithms are applied to the new data.

For the specific example shown in FIG. 4A and FIG. 4B, after the robot 10 arrives at base center 24 and the lidar data is obtained, a process is then carried out to align the robot 10 and target vehicle 12 in the desired orientation, which is shown in FIG. 1A. The first step in this process is to identify the left front wheel 16a and right front wheel 16b using the method described herein above. A straight line 18 between the centers of wheels 16a and 16b is determined and then entry point 20 on this line is located. In this example the entry point 20 is exactly in the middle of line 18, but in other cases entry point 20 might be located to the right or the left of the midpoint depending on one or more of: the model of target vehicle, e.g. for some vehicles the clearance at the front is only 17 cm; the location of parts attached to the undercarriage of the target vehicle, e.g. a gas tank; or, in some cases, on obstacles in the parking area close to the target vehicle, e.g. another parked vehicle or a wall. In the next steps an external travel line 22 perpendicular to line 18 and a base line 28 from base center 24 and parallel to the Y-axis is calculated. After the distance of the vehicle, its azimuth and its orientation have been found by the algorithm robot 10 then uses open loop navigation to travel along base line 28 to a point named goal 26 where base line intersects external travel line 22. Robot 10 reaches goal 26 and pivots about its center by an angle 30 to align itself with target vehicle 12 as shown in FIG. 1A.

In an alternate method, the robot 10 can navigate from base center 24 to entry point 20 directly in a closed loop manner using feedback from the lidar sensor to either an onboard or remote processor that is configured to activate the electric motors that drive the wheels of the robot to continually guide its direction and forward motion.

Although embodiments of the invention have been described by way of illustration, it will be understood that the invention may be carried out with many variations, modifications, and adaptations, without exceeding the scope of the claims.

### BIBLIOGRAPHY

1. WO2022/144901, Applicant: Charging Robotics Ltd., Published: 7 Jul., 2022.
2. Tian Zhang, Raghu Ramakrishnan, and Miron Livny, BIRCH: An Efficient Data Clustering Method for Very Large Databases, ACM SIGMOD Record, Volume 25, Issue 2, June 1996, pp. 103-114, https://doi.org/10.1145/235968.233324
3. Martin A. Fischler and Robert C. Bolles, Random Sample Consensus: A Paradigm for Model Fitting with Applications to Image Analysis and Automated Cartography, Communications of the ACM, Volume 24, Number 6, June 1981, pp. 381-395, https://dl.acm.org/doi/pdf/10.1145/358669.358692

1. A method for determining the distance and orientation of an autonomous partially autonomous mobile robot relative to a parked target vehicle from a base center, wherein the distance and orientation is used by the robot to navigate from the base center to a target location under the ground clearance of the target vehicle, the method comprising:
a) activating a lidar sensor mounted on the robot;
b) receiving data from the lidar sensor at an onboard or remote processor;
c) executing software in the processor configured to carry out a method for locating a pair of wheels on the front, back, or a side from which the robot will enter under the target vehicle;
d) executing software in the processor to locate an entry point between the pair of wheels located on the previous step from which the robot will enter underneath the target vehicle; and
e) executing software in the processor that is configured to carry out a navigation process that directs the robot from the base center to the entry point and from there underneath the vehicle.

2. The method of claim 1 comprising a first step of navigating the robot to the base center, which faces a front, back, or a side surface of the target vehicle.

3. The method of claim 1 comprising a last step of executing software in the processor that is configured to carry out a navigation process that directs the robot from the entry point to the target location.

4. The method of claim 2 comprising a last step of executing software in the processor that is configured to carry out a navigation process that directs the robot from the entry point to the target location.

5. The method of claim 1, wherein locating a pair of wheels comprises the steps of:
a) receiving raw data from a lidar sensor mounted on the robot;
b) applying the BIRCH algorithm on the raw data to find clusters of data points;
c) calculating the distance between all pairs of clusters;
d) determining if the distance between the two clusters in each of the pairs of clusters equals a predefined parameter plus or minus a predefined error, wherein; if the distance between clusters equals the parameter, then the pair is suspected to be a wheel pair and if the distance between clusters does not equal the parameter, then this pair is rejected;
e) applying a RANSAC algorithm to obtain a straight regression line on each of the two clusters from the pairs of clusters that are suspected to represent a pair of wheels;
f) calculate the angle between the two regression lines for each suspected pair; wherein, if the two regression lines are parallel, plus or minus a predefined error or if the two regression lines are perpendicular plus or minus a predefined error then it is certain that the pair of clusters represents a pair of wheels.

6. The method of claim 1, wherein the maximum height of the robot and any sensors or equipment mounted on it is lower than the ground clearance of the vehicle.
